(19) United States
(12) Patent Application Publication
(10) Pub. No.: US 2026/0292399 A1
(43) Pub. Date: Sep. 24, 2026

(54) POSITIONAL AND ECHO AUDIO ENHANCEMENT

(71) Applicant: Citrix Systems, Inc., Fort Lauderdale, FL (US)

(72) Inventors: Mingming Ren, Nanjing (CN); Zhaohui Mei, Nanjing (CN); Juanjuan Chen, Nanjing (CN); Yuan Zhang, Nanjing (CN); Yajun Yao, Nanjing (CN)

(21) Appl. No.: 18/874,156

(22) PCT Filed: Sep. 28, 2022
(86) PCT No.: PCT/CN2022/122043

§ 371 Date: Dec. 12, 2024

(51) Int. Cl. H04R 3/02; G06F 3/16; H04R 1/40; H04R 3/00; H04S 7/00

(52) U.S. Cl. CPC H04R 3/02; G06F 3/162; H04R 1/406; H04R 3/005; H04S 7/30; H04R 2420/07; H04S 2400/11

(57) ABSTRACT

A method of using multiple audio streams to enhance audio output is provided. A plurality of computing devices can elect one of the plurality of devices as a leader device. A first follower device of the plurality of computing devices can send a first audio stream to the leader device. The leader device can process the first audio stream to obtain an output. The leader device can send the output to a second device. A remote device can play an enhanced audio stream based on the output, wherein the enhanced audio stream comprises an echo enhanced audio stream and/or a positionally enhanced audio stream.

### RELATED APPLICATIONS

This application claims the benefit of and is a National Stage Application under 35 U.S.C. § 371 of Patent Cooperation Treaty (PCT) Application No. PCT/CN2022/122043 (filed Sep. 28, 2022), which is incorporated here by reference in its entirety.

### BACKGROUND

In the post-pandemic era, more and more organizations have adopted a hybrid working mode, with some employees working at an office and others working remotely. It is increasingly common that a meeting has both remote participants and physical participants at the same time.

Consider a meeting in which some participants are in a same physical meeting room, while other participants dial in remotely. For the physical meeting room, usually only one audio input device is used, which can be a microphone of a specific computer, or a speakerphone device which integrates a microphone or microphone array. In all these situations, each physical participant's positional information is lost.

Moreover, a common practice is to keep only one microphone and one speaker powered on, while all others are deactivated. Otherwise, acoustic echo and even howling will likely occur. But sharing a single microphone and speaker within the whole room, or manually switching between different person's audio devices may result in poorer sensitivity and sound quality, both for remote and physical participants.

### SUMMARY

In at least one example, a method of using multiple audio streams to enhance an audio output is provided. The method includes electing, by a plurality of computing devices, one of the plurality of computing devices as a leader device. The method further includes sending, by a first follower device of the plurality of computing devices, a first audio stream to the leader device. The method further includes processing, by the leader device, the first audio stream to obtain an output based on the first audio stream. The method further includes sending, by the leader device, the output to a second device. The method further includes playing, by a remote device, an enhanced audio stream based on the output. The enhanced audio stream can comprise an echo enhanced audio stream and/or a positionally enhanced audio stream.

At least some examples of the method of using multiple audio streams to enhance an audio output can include one or more of the following features. In the method, the enhanced audio stream can comprise the positionally enhanced audio stream. Sending, by the first follower device, the first audio stream can comprise playing, by the first follower device, a sample sound. Processing the first audio stream can comprise determining a direction and/or a distance to the first device. The output can comprise a global participant map comprising the determined direction and/or distance. The method can further comprise processing a live audio stream based on the global participant map to obtain the positionally enhanced audio stream.

In the method, processing the live audio stream based on the global participant map can comprise delaying at least one channel of the live audio stream based on the global participant map.

In the method, delaying the at least one channel can further comprise computing a distance formula based on a square of the distance and/or a cosine of an angle associated with the direction.

In the method, determining the direction and/or distance to the first device may comprise sensing, by a plurality of microphones of the leader device, the sample sound.

In the method, determining the direction and/or distance to the first device may comprise determining, by the leader device, a signal strength of a wireless signal transmitted by the first device.

In the method, processing the live audio stream based on the global participant map can comprise one or more of: processing, by the leader device, the live audio stream; processing, by the second device, the live audio stream, wherein the second device differs from the remote device; or processing, by the remote device, the live audio stream.

In the method, determining the direction and/or distance can comprise performing a beamforming and/or time difference of arrival (TDOA) analysis.

In the method, the enhanced audio stream can comprise the echo enhanced audio stream. The first audio stream can comprise a live audio stream. Processing the first audio stream can comprise canceling echo in the live audio stream to obtain the echo enhanced audio stream. The output can comprise the echo enhanced audio stream. The second device can comprise the remote device.

In the method, canceling the echo in the live audio stream can comprise receiving, by the leader device, a second live audio stream. Canceling the echo in the live audio stream can comprise removing, by the leader device, a feature of the second live audio stream from the live audio stream to obtain a first echo-canceled stream. Canceling the echo in the live audio stream can comprise removing, by the leader device, a feature of the live audio stream from the second live audio stream to obtain a second echo-canceled stream. Canceling the echo in the live audio stream can comprise merging, by the leader device, the first echo-canceled stream and the second echo-canceled stream to obtain the echo enhanced audio stream.

In the method, removing the feature of the second live audio stream from the live audio stream can comprise processing the live audio stream with an Audio Processing Module (APM) associated with the second live audio stream.

In the method, sending the first audio stream to the leader device can comprise removing, by the first follower device, a feature of a remote audio stream from the live audio stream. The remote audio stream can be received from the remote device.

In the method, electing the leader device can comprise obtaining a network accessible by the plurality of computing devices. Electing the leader device can comprise broadcasting, by a respective device of the plurality of computing devices, a respective resource capacity of the respective device via the network or a wireless signal. Electing the leader device can comprise executing a consensus process to elect the leader device based on the respective resource capacity.

In the method, the consensus process can comprise one or more of a Raft process or a Paxos process.

In at least one example, a client computer system configured to enhance an audio output is provided. The client computer system includes a memory and at least one processor coupled to the memory. The at least one processor is configured, responsive to being elected by a plurality of computing devices as a leader device, to receive, from a first follower device of the plurality of computing devices, a first audio stream. The at least one processor is further configured to process the first audio stream to obtain an output based on the first audio stream. The at least one processor is further configured to send the output to a second device. A remote device can be configured to play an enhanced audio stream based on the output. The enhanced audio stream can comprise an echo enhanced audio stream and/or a positionally enhanced audio stream.

At least some examples are directed to a non-transitory computer readable medium storing executable instructions to enhance an audio output. In these examples, the instructions can be encoded to execute any of the acts of the method of using multiple audio streams to enhance an audio output described above.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram illustrating a system for positional audio enhancement, in accordance with an example of the present disclosure.

FIG. 2 is a block diagram illustrating a system for echo cancellation audio enhancement, in accordance with an example of the present disclosure.

FIG. 3 illustrates leader election, in accordance with an example of the present disclosure.

FIG. 4A illustrates position detection, in accordance with an example of the present disclosure.

FIG. 4B illustrates adjustment of positional audio, in accordance with an example of the present disclosure.

FIG. 4C illustrates delay calculation for left and right channels, in accordance with an example of the present disclosure.

FIG. 5 is a communication flow diagram illustrating a method for positional audio enhancement, in accordance with an example of the present disclosure.

FIG. 6 is a communication flow diagram illustrating a method for echo cancellation audio enhancement, in accordance with an example of the present disclosure.

FIG. 7 is a flow diagram of a process for using multiple audio streams to enhance an audio output, in accordance with an example of the present disclosure.

FIG. 8A is a flow diagram of a process for positional audio enhancement, in accordance with an example of the present disclosure.

FIG. 8B is a flow diagram of a process for adjustment of positional audio, in accordance with an example of the present disclosure.

FIG. 9A is a flow diagram of a process for echo cancellation audio enhancement, in accordance with an example of the present disclosure.

FIG. 9B is a flow diagram illustrating further details of canceling echo, in accordance with an example of the present disclosure.

FIG. 10 is a flow diagram illustrating further details of electing a leader node, in accordance with an example of the present disclosure.

FIG. 11 is a block diagram of an example system for positional audio enhancement, in accordance with an example of the present disclosure.

FIG. 12 is a block diagram of a computing device configured to implement various systems and processes in accordance with examples disclosed herein

### DETAILED DESCRIPTION

As summarized above, various examples described herein are directed to systems and methods to use multiple audio streams to enhance an audio output. The disclosed systems and methods can adjust audio streams to reflect the physical position of various streams in a hybrid or video meeting, and to cancel echo and prevent feedback noise.

In the post-pandemic era, more organizations have adopted a hybrid working mode, with some employees working at an office and others working remotely. It is increasingly common that a meeting has both remote participants and physical participants at the same time.

Consider a meeting in which some participants are in a same physical meeting room, while other participants dial in remotely. For the physical meeting room, usually only one audio input device is used, which can be a microphone of a specific computer, or a speakerphone device which integrates a microphone or microphone array. In all these situations, each physical participant's positional information is lost. As a result, for the remote participant, people in the physical room are spatially “overlapped”, in that they sound like in the same physical position. Especially when two people in the same physical room speaking at the same time, it's hard to distinguish one from another from the remote participants' perspective. However, for the people in the same room, it's easy to distinguish one voice from another. Because the positional information is not lost, and our ears can easily identify speakers based on their different spatial characteristics.

With participants in the same physical meeting room, a common practice is to keep only one microphone and one speaker powered on, while all others are deactivated. Otherwise, acoustic echo and even howling are likely to occur. But sharing a single microphone and speaker within the whole room, or manually switching between different person's audio devices is not a good experience, both for remote and physical participants.

This disclosure describes a mechanism that each physical participant can use his/her own audio device at the same time, without generating echo and howling. The disclosed system and methods can use discovery and leader election to negotiate and form a local cluster. Moreover, the disclosed system and methods can process audio streams on a central node before sending them out to the remote side. The disclosed system and methods can perform echo cancellation on multiple streams captured by different hosts.

A method of using multiple audio streams to enhance an audio output is provided. A plurality of computing devices or nodes can elect one of the plurality of nodes as a leader node. A first follower node of the plurality of computing nodes can send a first audio stream to the leader node. The leader node can process the first audio stream to obtain an output. The leader node can send the output to a second node. A remote node can play an enhanced audio stream based on the output, wherein the enhanced audio stream comprises an echo enhanced audio stream and/or a positionally enhanced audio stream.

The systems and processes described herein to enhance an audio output can be implemented within a variety of computing resources. For instance, in some examples, the systems and processes are implemented within a virtualization infrastructure, such as the HDX™ virtualization infrastructure commercially available from Citrix Systems of Fort Lauderdale, Florida, in the United States. In these examples, the disclosed systems and processes can be implemented within a workspace client application (also referred to as a digital workspace application), such as the Citrix Workspace™ application; a browser embedded within the workspace client application; a secure browser service, such as the Citrix Secure Browser™ service; a gateway appliance, such as the Citrix Application Delivery Controller™ (ADC); a virtualization agent, and/or other computing resources.

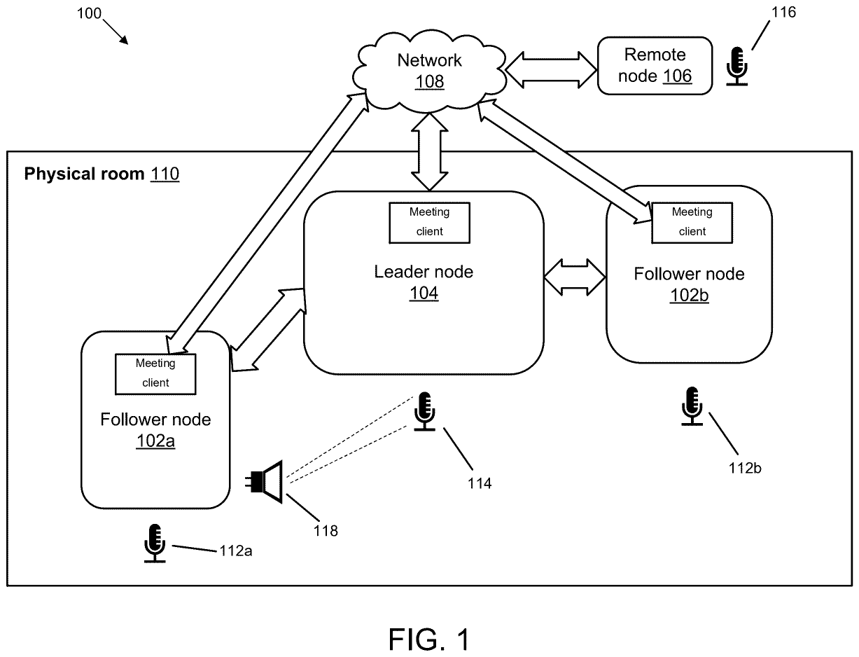

FIG. 1 is a block diagram illustrating a system 100 for positional audio enhancement, in accordance with an example of the present disclosure. In this example, the system 100 can include a local computing cluster including a plurality of computing nodes and/or devices, such as follower nodes 102a and 102b and a leader node 104. The process for selecting the leader node 104 from among the plurality of computing nodes will be described below. In this example, the plurality of computing nodes may be co-located at the same site or location, such as in the same physical room 110, and may take part in a hybrid mode meeting, such as an audio and/or video meeting. For example, the follower nodes 102a and 102b and the leader node 104 may each belong to a meeting participant, such as Alice, Charlie, and Bob, respectively. The hybrid mode meeting may also include remote participants, such as Dan, who may connect to the meeting via one or more remote nodes 106. The remote nodes 106 can communicate with the nodes in the physical room 110 via a network 108, such as the Internet or any other network, or via any other means of transmission.

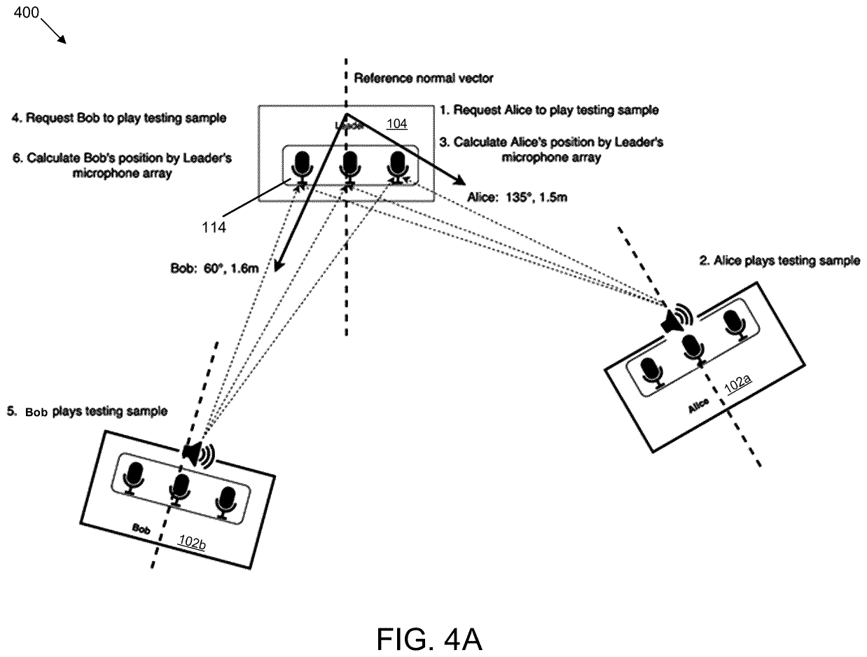

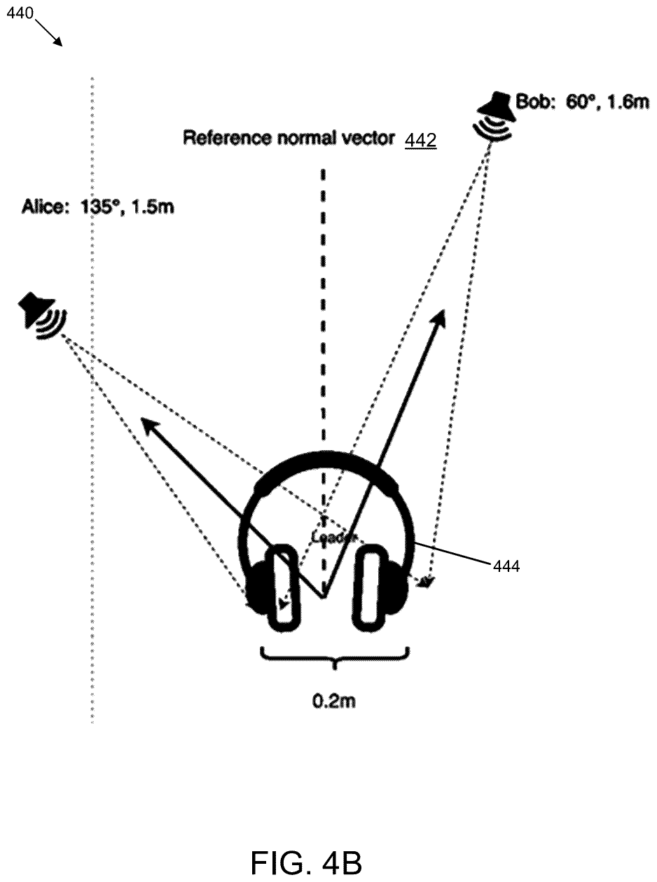

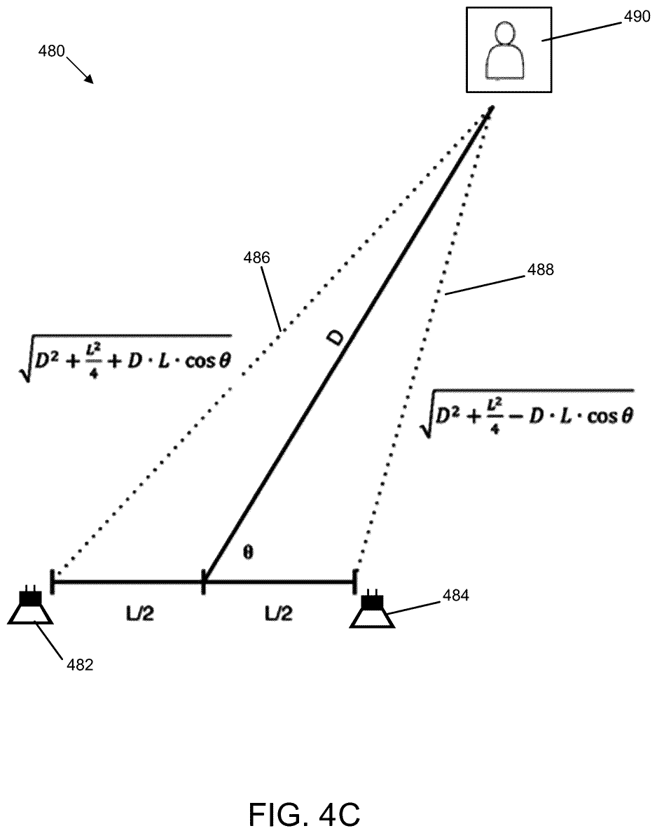

In this example, the plurality of computing devices can have microphones to sense the speech of their respective users. For example, the follower nodes 102a and 102b may have microphones 112a and 112b, respectively, the leader node 104 may have a microphone 114, and the remote node 106 may have a microphone 116. In some examples, each node may have a microphone array that can be used to determine a direction to the source of a sound, for example by comparing the timing of the sound sensed by the microphones in the array, as described in FIG. 4A below. In addition, the plurality of computing devices can execute meeting clients, which can communicate via the network 108, or via another means of communication, to send and receive audio and/or video streams, as well as chat messages or any other data, with the local and/or remote nodes.

In addition, the plurality of computing devices may possess audio speakers that can play the audio streams and/or other sounds. For example, the configuration 100 can be used to develop a global participant map of the relative positions of each of the plurality of nodes, and modify the meeting audio stream to reflect these positions. As shown, the speaker 118 of the follower node 102a can play a sample sound that can be sensed by the microphone 114 of the leader node 104. The leader node 104 can use the sensed sample sound to determine a direction and/or distance to the follower node 102a relative to its own reference normal vector, as described in FIG. 4A below.

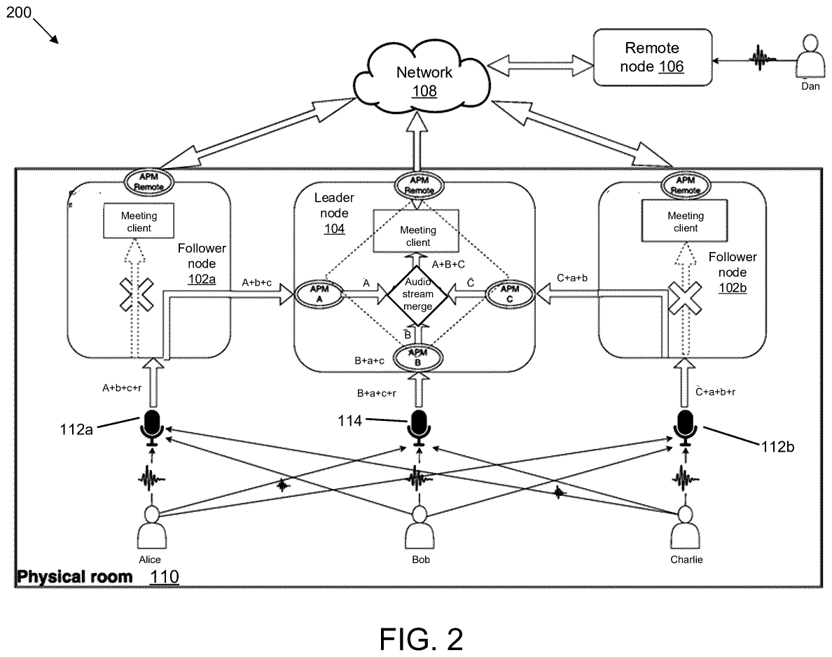

FIG. 2 is a block diagram illustrating a system 200 for echo cancellation audio enhancement, in accordance with an example of the present disclosure. The system 200 can include a local computing cluster including a plurality of computing nodes and/or devices, such as follower nodes 102a and 102b and a leader node 104. The process for selecting the leader node 104 will be described below. The plurality of computing nodes may be co-located at the same site or location, such as in the physical room 110, and may take part in a hybrid mode meeting, such as an audio and/or video meeting. For example, the follower nodes 102a and 102b and the leader node 104 may each belong to a meeting participant, such as Alice, Charlie, and Bob, respectively. The hybrid mode meeting may also include remote participants, such as Dan, who may connect to the meeting via one or more remote nodes 106. The remote nodes 106 can communicate with the nodes in the physical room 110 via a network 108, such as the Internet or any other network, or via any other means of transmission.

As in the example of FIG. 1, the plurality of computing devices can have microphones to sense the speech of their respective users, and can execute meeting clients, which can communicate with the local and/or remote nodes via the network 108 or another means of communication.

The configuration 200 can be used to remove echoes from the meeting's audio stream, for example, when stray sounds from the various speakers are detected by other nodes' microphones, as illustrated. In this example, Bob's machine has been selected as the leader node 104, as will be described herein below. Accordingly, the leader node 104 can create an Audio Processing Module (APM) data structure for each of the local follower nodes 102a and 102b, as well as for the remote audio stream. Likewise, the local follower nodes 102a and 102b can create APMs for the remote audio stream, denoted as APM_remote. In some examples, the APMs may be the core data structures used for audio processing for the respective audio streams.

The meeting clients may be disconnected from the follower nodes' physical audio input devices. Accordingly, a single processed stream, such as a merged echo enhanced audio stream, from the leader node 104 can be sent to the remote nodes 106. In some examples, the leader node 104 can create a respective APM for each local follower node 102a and 102b, as well as an APM for Bob's own input stream. In this example, the microphone 112a of Alice's machine 102a may capture a mixed stream, including Alice's voice as the principal component, as well as the attenuated voices of Bob and Charlie, and possibly some attenuated remote audio played by speakers of neighboring nodes. This mixed stream may be denoted as (A+b+c+r). To leverage the resources of Alice's machine 102a, and decrease the computational burden of the leader node 104, the node 102a can use its APM_remote to extract features of the remote audio stream (e.g., Dan's voice) and remove these features from Alice's captured audio stream. After removal of the remote component, Alice's node 102a can send the resulting stream, A+b+c to the leader node 104. The leader node 104 can then process the received streams to remove echo (e.g., it can process Alice's stream A+b+c to remove the attenuated components b and c from Bob and Charlie, respectively), as described herein below.

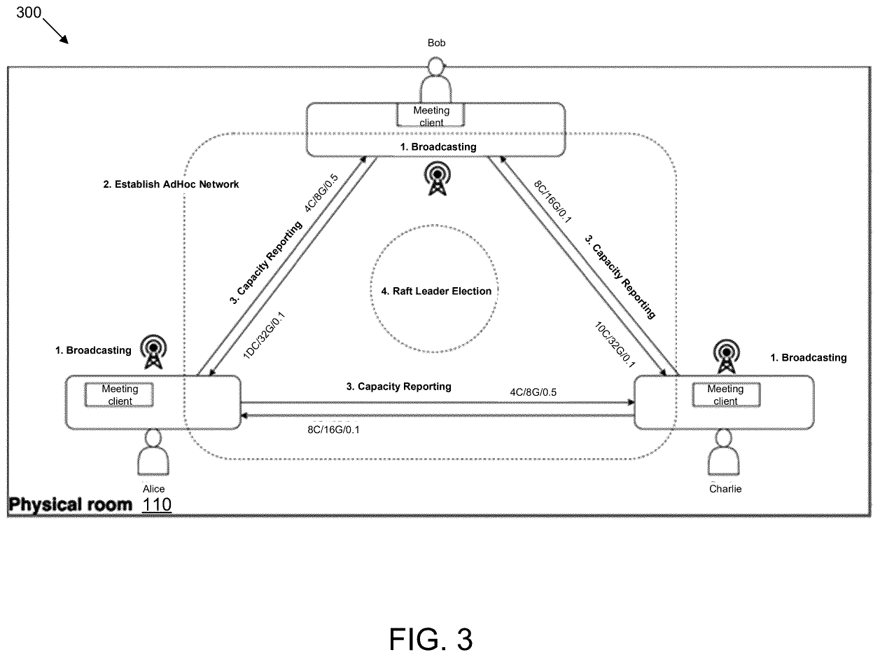

FIG. 3 illustrates a leader election 300, in accordance with an example of the present disclosure. In some examples, local nodes in the same physical 110 room can discover each other. For example, each node may broadcast its machine identity and meeting identity to its neighbors, for example via Bluetooth or NFC. Upon receiving identity information from neighbors, each node can then filter out any nodes with meeting identities not corresponding to the current meeting. A cluster can then be established among all the machines in the room that have not been filtered out, for example via Bluetooth or Wireless Ad-hoc Network (WANET). Each node can then broadcast its resource capacity (such as its CPU type, memory, current computing load, communication bandwidth, number of microphones, etc.) via the established WANET.

Upon receiving resource reports from its neighbors, each node can decide whether to adopt a candidate or follower status for the election procedure. For example, some nodes may spontaneously choose not to pursue leader candidacy, for example if the nodes have less resource capacity than their neighbors (e.g., slower or less powerful CPU type, lower number of CPUs, lower memory capacity, higher current computing load, lower communication bandwidth, fewer microphones, or the like), thereby accelerating and optimizing the election process. Conversely, those nodes with relatively high resource capacity (e.g., more powerful CPU type, higher number of CPUs, greater memory capacity, lower current computing load, or the like) may volunteer as candidates to become the leader node.

The plurality of computing nodes can then execute a consensus process to elect the leader node, for example based on resource capacity. In some examples, the consensus process can include a Raft process and/or a Paxos process. Such algorithms can guarantee that exactly one node is elected as the leader node. Accordingly, all the other local nodes can adopt a follower node status. The elected leader node may perform a leader role in positional audio enhancement and/or echo enhancement, as disclosed herein.

For example, in the Raft process, a leader election may begin if no heartbeat signal is received during an election timeout period. For example, a node may vote for itself as the leader node, and may request the vote of the plurality of computing nodes, or any subset thereof. In another example, in the Paxos process, a respective node may offer a proposal to become the leader node. If the proposal is accepted by sufficient nodes, the respective node may become the leader node.

Subsequently, if the elected leader node crashes, goes offline, or experiences a resource shortage, the cluster may return to the leader election phase 300, and elect a new leader node. In some examples, APM data can be transferred from the old leader node to the new leader to minimize “cold-start” issues and accelerate the procedure. In one example of positional audio enhancement, if the leader node changes, the system may retain the same positional information, such as the same global participant map, and the new leader node may process the audio streams based on the existing map.

FIG. 4A illustrates position detection 400, in accordance with an example of the present disclosure. As illustrated in this example, the position detection phase 400 may include several steps. The leader node 104 may first send a request to Alice's follower node 102a to play a testing sample sound. In response, Alice's node 102a can play the sample sound via one or more audio speakers.

The leader node's microphone array 114 can detect the testing sample played by the follower node 102a, and accordingly the leader node 104 can calculate a position associated with Alice. For example, the position may include a direction and/or a distance to the node 102a.

In an example, the leader node 104 may use a difference Δt in timing of the sample sound, as sensed by a respective pair of microphones of the leader node's microphone array 114, multiplied by the speed cs of sound, to compute a difference in distance traveled by the sample sound to the respective pair of microphones. For example, if the leader node's microphone array 114 includes at least three microphones, the leader node 104 may use multiple timing differences between respective pairs of microphones in the array 114. For example, if the distance to Alice's node 102a is denoted as DA, and an azimuthal angle to the node 102a in the horizontal plane is denoted as 0A, the leader node 104 may use a formula such as

$${C}_{s} Δ t = \sqrt{{D}_{A}^{2} + \frac{{L}_{m}^{2}}{4} + {D}_{A} {L}_{m} cos {θ}_{A}} - \sqrt{{D}_{A}^{2} + \frac{{L}_{m}^{2}}{4} - {D}_{A} {L}_{m} cos {θ}_{A}}$$

where Δt is the timing difference, and Lₘ is the spacing between the microphones in the respective pair. In some examples, the azimuthal angle θ_{A} may be measured from a reference normal vector of the leader node 104.

In order to solve for both unknowns DA and θA, the leader node 104 may use two such equations for two respective pairs of microphones in the array 114. In some examples, if the leader node and/or other nodes are only able to use a single microphone, the system may generate pseudo-positional information.

The leader node 104 can then send a request to Bob's follower node 102b to play a testing sample sound. In response, the node 102b may play the sample sound. The leader node's microphone array 114 may then detect the sample sound, and the leader node 104 can then calculate a position associated with Bob, as described above.

This iterative procedure can continue until all the local follower nodes 102 are located. In some examples, other follower nodes may also calculate the relative location of each follower when it plays the sample sound. The leader node 104 can then generate and share a global view of participant position with all clients.

FIG. 4B illustrates adjustment 440 of positional audio by a remote node, in accordance with an example of the present disclosure. As described in the example of FIG. 4A above, the leader node 104 and/or another node can generate a global participant map featuring the positions of all the local nodes. Depending on the processing mode, the leader node 104, follower nodes 102, and/or the remote nodes 106 can then adjust 440 a delay in the channels of the audio stream, so as to represent the individual meeting participants' positions.

In this example, the one or more remote nodes 106 can use a playback system 444, such as a stereo headset, earphones, or audio speakers, to play two or more channels of the positionally enhanced audio stream. The channels may have a relative delay chosen to represent the positions of the individual meeting participants, as described in the example of FIG. 4C below. For example, the playback system 444 can be oriented along a reference normal vector 442. The vector 442 can be chosen to align with the reference normal vector of the leader node, so that the delays are chosen based on angles to the individual participants relative to the reference normal vector 442.

FIG. 4C illustrates delay calculation 480 for left and right channels, in accordance with an example of the present disclosure. In this example, two stereo speakers or earphones 482 and 484 may be separated by a distance L. The global participant map may show that a particular meeting participant is located a distance D from the leader node and/or at an azimuthal angle θ relative to the leader node's reference normal vector, as described in the example of FIG. 4A. As illustrated, in this example, the source 490 of the sound appears to be located at the same distance D and/or at azimuthal angle θ relative to the two stereo speakers or earphones 482 and 484. Moreover, in this example, D is measured from the midpoint of the speakers or earphones 482 and 484.

Accordingly, as in the example of FIG. 4A, the delay Δt between the channels corresponding to the two stereo speakers or earphones 482 and 484 may be related to D, L, and 0 by a formula such as

$${C}_{s} Δ t = \sqrt{{D}^{2} + \frac{{L}^{2}}{4} + DL cos θ} - \sqrt{{D}^{2} + \frac{{L}^{2}}{4} - DL cos θ}$$

where cₛ is the speed of sound. As illustrated, this is because the distance from each audio speaker or earphone to the apparent source 490 of the sound differs. In this example, the distance 486 from the left speaker 482 to the apparent source 490 is while the distance 488 from the right speaker 484 to the apparent source 490 is

$$\sqrt{{D}^{2} + \frac{{L}^{2}}{4} + DL cos θ}$$

Accordingly, the difference between these two distances corresponds to cₛΔt.

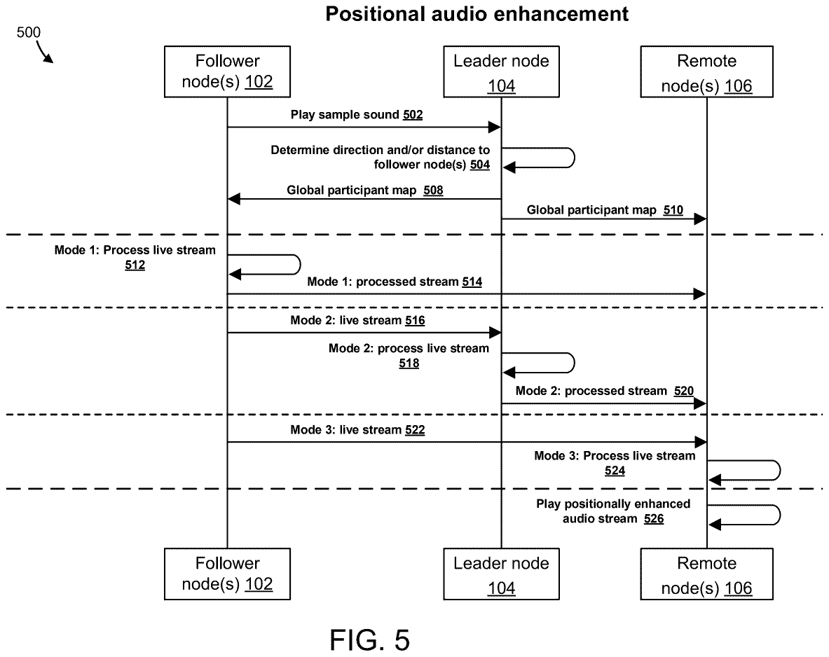

FIG. 5 is a communication flow diagram illustrating a method 500 for positional audio enhancement, in accordance with an example of the present disclosure. The steps of the method 500 may be performed by the cluster 100, including the leader node 104 and the follower nodes 102, and/or by the one or more remote nodes 106, as shown in FIGS. 1-2. For example, the follower nodes 102 may be in the same physical room as the leader node 104. Alternatively or additionally, some or all of the steps of the method 500 may be performed by one or more other computing devices. The steps of the method 500 may be modified, omitted, and/or performed in other orders, and/or other steps added.

At step 502, the follower node 102 may play a sample sound, which the leader node 104 can sense. In some examples, the follower node 102 may play the sample sound in response to a request from the leader node 104. The follower node 102 may be a first follower node of a plurality of computing nodes of the cluster 100. For example, the leader node 104 may iteratively request each local follower node 102 to play a sample sound.

In some examples, the follower node 102 may play the sample sound via one or more audio speakers, and the leader node 104 may sense the sample sound using one or more microphones, such as an array of microphones. Alternatively or additionally, in some examples the first follower node can transmit a wireless signal, such as a cellular, Bluetooth, and/or near-field communication (NFC) signal.

At step 504, the leader node 104 can determine a direction and/or a distance to the follower node 102. In some examples, determining 504 the direction and/or distance can be based on the relative delays of the sample sound, as sensed by respective microphones of a microphone array of the leader node, as described in the example of FIG. 4A above. In some examples, the leader node 104 may iteratively determine the direction and/or distance to each local follower node.

At step 508, the leader node 104 can send the global participant map to the follower node 102. In some examples, the leader node 104 may determine the directions and/or distances to all local nodes, and/or to any subset of the local nodes, and therefore the global participant map may include all these determined directions and/or distances. The leader node 104 may then send the global participant map to all the follower nodes. The leader node 104 may send the global participant map via the cluster, e.g. via the established WANET, via another network, or via any other means of transmission.

In some examples, at step 510, the leader node 104 may also send the global participant map to the one or more remote nodes 106. In some examples, the leader node 104 sends the global participant map to the remote nodes 106 in the case that the mode of operation corresponds to a remote processing mode, as described herein below. Alternatively, in some cases, the system may use a distributed processing mode, and therefore the leader node 104 may send the global participant map only to the local follower nodes 102, or the leader node 104 may use a centralized processing mode, and therefore may not send the global participant map to any other nodes.

Next, the system can process a live audio stream based on the global participant map to obtain a positionally enhanced audio stream. In various examples, the method 500 may make use of various modes of operation to process the live stream. In some examples, the mode may be predetermined, whereas in other cases, the mode may be set by a user option.

For example, in the distributed processing mode, each follower node 102 can alter its captured audio data based on its relative location in the global view 508, to reflect its positional acoustic characteristics. In the centralized processing mode, the leader node 104 is responsible to alter each audio stream based on the global participant map, and merge the streams. In the remote processing mode, the global participant map 510 can be sent to the remote nodes 106 along with the audio streams, and the remote nodes 106 are then responsible to alter the audio stream acoustic characteristics.

For example, in the distributed processing mode, at step 512, the follower node 102 can process its own live stream based on the global participant map 508. In some examples, the live audio stream may include the audio captured from microphones in a meeting, for example in a physical room with the leader node 104 and local follower node 102, as illustrated in FIG. 1. In particular, the follower node 102 can adjust a delay of channels (e.g., stereo channels) in the live stream based on its own direction and/or distance in the global participant map 508, as described in FIGS. 4B-4C above. At step 514, the follower node 102 can then send the processed stream to the remote nodes 106, so that remote participants can distinguish each local participant's location based on the relative delay of the stereo channels. The remote node may merge the plurality of received positionally enhanced audio streams.

In the centralized processing mode, at step 516, the follower node 102 can send its live stream to the leader node 104. At step 518, the leader node 104 can then process the received live stream 516 based on the global participant map, as described in FIGS. 4B-4C above. In some examples, processing the live audio stream may also include merging a plurality of processed streams, e.g. from different follower nodes, into a single positionally enhanced output stream. At step 520, the leader node 104 can send the processed output stream to the remote nodes 106.

In the remote processing mode, at step 522, the follower node 102 can send its live stream to the remote nodes 106. At step 524, the remote nodes 106 can process the received live stream 522 based on the global participant map 510, as described in FIGS. 4B-4C above.

At step 526, the remote nodes 106 can play the positionally enhanced audio stream. Accordingly, when a remote node 106 plays the positionally enhanced audio stream, a user of the remote node can hear a reconstruction of the actual positions of local members of the meeting based on the global participant map (e.g., the streams with adjusted delays corresponding to the relative positions of the meeting participants), as described in the example of FIG. 4B above.

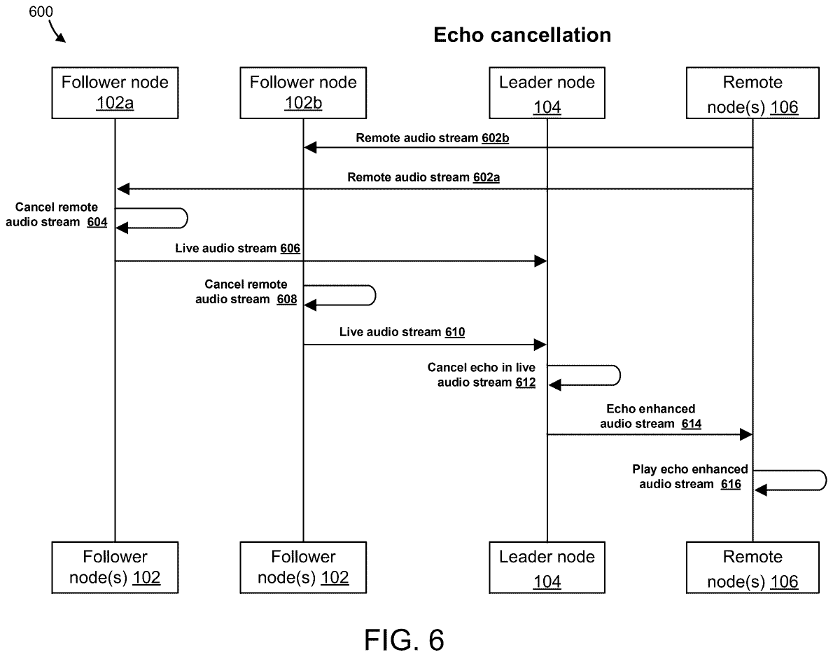

FIG. 6 is a communication flow diagram illustrating a method for echo cancellation audio enhancement, in accordance with an example of the present disclosure. The steps of the method 600 may be performed by the cluster 100, including the leader node 104 and the follower nodes 102a and 102b, and/or by the one or more remote nodes 106, as shown in FIGS. 1-2. For example, the follower nodes 102a and 102b may be in the same physical room as the leader node 104. Alternatively or additionally, some or all of the steps of the method 600 may be performed by one or more other computing devices. The steps of the method 600 may be modified, omitted, and/or performed in other orders, and/or other steps added.

At steps 602a and 602b, the one or more remote nodes 106 may send the remote audio stream to the follower nodes 102a and 102b, respectively. In some examples, the one or more remote nodes 106 may also send the remote audio stream to the leader node 104. The remote audio streams 602a and 602b may comprise the audio streams sensed by the microphones of the one or more remote nodes 106. In some examples, the follower nodes 102a and 102b may play the remote audio stream, for example through speakers and/or a headset, so that the users of the respective follower nodes can hear the speech of users of the remote nodes 106.

In some examples, the follower nodes 102a and 102b may store and/or manipulate the received remote audio streams 602a and 602b, respectively, for example using an APM data structure. For example, each node, including the follower nodes 102a and 102b and the leader node 104, may have an APM data structure, denoted as APM_remote, configured to store and/or manipulate the remote audio stream, as shown in FIG. 2. In one example, the nodes may have multiple APMs to contain multiple remote audio streams from multiple remote nodes. In another example, if there are multiple remote audio streams, they may be merged into a single remote audio stream before being stored and/or manipulated by APM_remote.

At step 604, a first follower node 102a can remove the remote audio stream from its own live audio stream. For example, the first follower node 102a may play the remote audio stream, as described above. When the first follower node 102a plays the remote audio stream, this remote audio may then be sensed by the first follower node's own microphones, which can then cause feedback noise. The first follower node 102a may therefore remove the remote audio stream from its own live audio stream, so as to prevent such feedback noise.

For example, the first follower node 102a can use a command such as APM_Remote.ProcessReverseStream (Stream_Remote) to obtain the received remote audio stream from the APM_remote. In an example where the first follower node 102a belongs to a user named Alice, the first follower node 102a may then use a command such as APM_Remote.ProcessStream (Stream_Alice) to remove the remote audio stream from its own live audio stream.

At step 606, the first follower node 102a can send its own processed live audio stream, with the remote audio stream removed, to the leader node 104. In an example where the leader node 104 belongs to a user named Bob, the first follower node 102a can use a command such as SendStreamTo (Bob) to send its own processed live audio stream to the leader node

104. The first follower node 102a may send the processed live audio stream via the cluster, e.g. via the established WANET, via another network, or via any other means of transmission.

At step 608, a second follower node 102b can remove the remote audio stream from its own live audio stream. The second follower node 102b may likewise remove the remote audio stream from its own live audio stream, so as to prevent feedback noise.

For example, the second follower node 102b can use a command such as APM_Remote.ProcessReverseStream (Stream_Remote) to obtain the received remote audio stream from the APM_remote. In an example where the second follower node 102b belongs to a user named Charlie, the second follower node 102b may then use a command such as APM_Remote.ProcessStream (Stream_Charlie) to remove the remote audio stream from its own live audio stream.

At step 610, the second follower node 102b can send its own processed live audio stream, with the remote audio stream removed, to the leader node 104. For example, the second follower node 102b may use a command such as SendStreamTo (Bob) to send its own processed live audio stream to the leader node 104. The second follower node 102b may send the processed live audio stream via the cluster, e.g. via the established WANET, via another network, or via any other means of transmission.

At step 612, the leader node 104 can cancel echoes in the received live audio streams 606 and 610 to obtain an echo enhanced audio stream. For example, the leader node 104 can remove the second live audio stream 610 from the first live audio stream 606, and likewise can remove the first live audio stream 606 from the second live audio stream 610. Accordingly, the leader node 104 can obtain a cleaned audio stream for each local follower node. The leader node 104 may then merge these individual echo-canceled streams into a single merged audio stream.

At step 614, the leader node 104 can send the merged, echo enhanced audio stream to the one or more remote nodes 106. In some examples, the leader node 104 may send the echo enhanced audio stream to the one or more remote nodes 106 via the Internet or any other network, or via any other means of transmission. For example, the leader node 104 may send the echo enhanced stream to the meeting client, which can then send the echo enhanced stream to the remote nodes 106 via a network 108, as in the example of FIG. 2.

Finally, at step 616, the one or more remote nodes 106 can play the echo enhanced audio stream 614. Since each attendee's voice has been captured by the nearest microphone, the disclosed system and methods can achieve optimal audio sensitivity for each speaker. Moreover, because echoes from the remote and local participants are removed from each stream, the disclosed system and methods can prevent or greatly reduce echo and feedback noise.

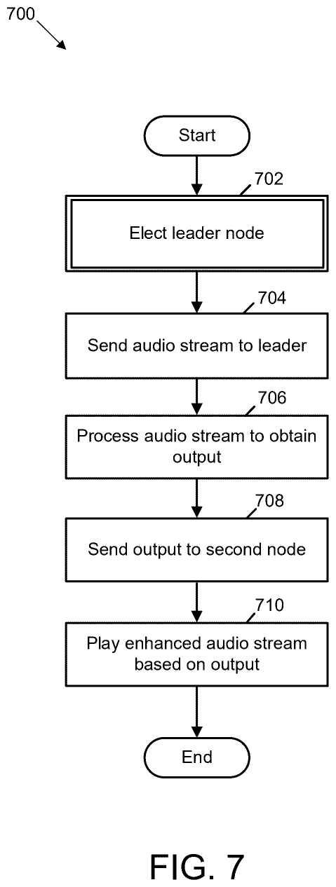

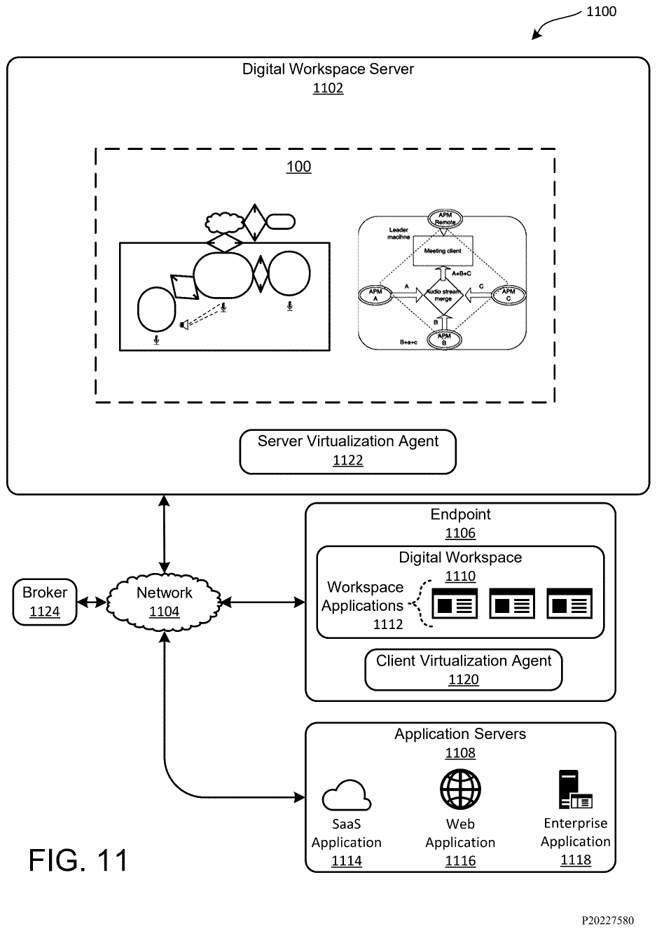

FIG. 7 is a flow diagram of a process 700 for using multiple audio streams to enhance an audio output, in accordance with an example of the present disclosure. In various examples, the process 700 may be implemented by a plurality of computing nodes, which may include local nodes and/or remote nodes, as in the examples of FIGS. 1 and 2 above. Alternatively or additionally, the process 700 may be executed by a single device, or may be implemented within a virtualization infrastructure, as described in the example of FIG. 11 below, and is not limited by the present disclosure. In some examples, the process 700 may enhance an audio stream, such as from a distance or hybrid work mode meeting, to an echo enhanced audio stream and/or a positionally enhanced audio stream, as described in the examples of FIGS. 1, 2, 4A-4C, 5, and 6 above.

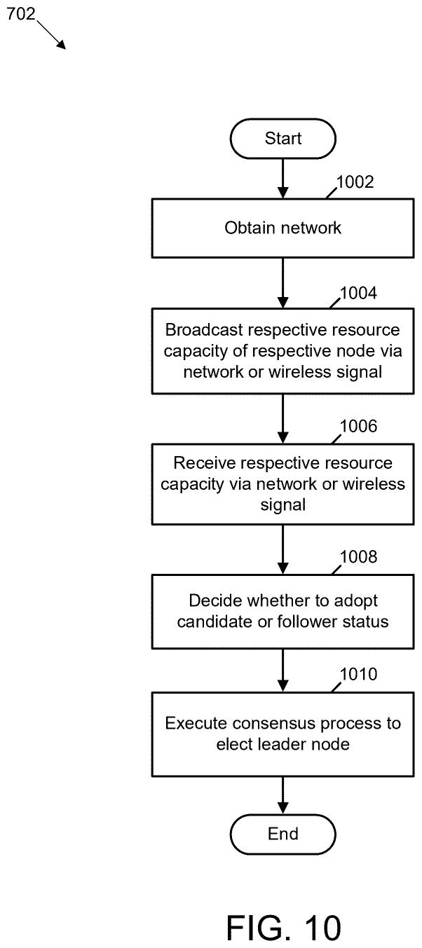

As shown in FIG. 7, the process 700 for using multiple audio streams to enhance an audio output starts with the plurality of computing nodes electing 702 one of the plurality of computing nodes as a leader node. In some examples, electing 702 a leader node is based on the capacity of each node, for example by selecting the node with the greatest capacity as the leader. This process is described in greater detail in the examples of FIG. 3 above and FIG. 10 below. In some examples, the elected leader node can process audio streams from the other nodes, and/or can be used to determine a reference direction, as described below.

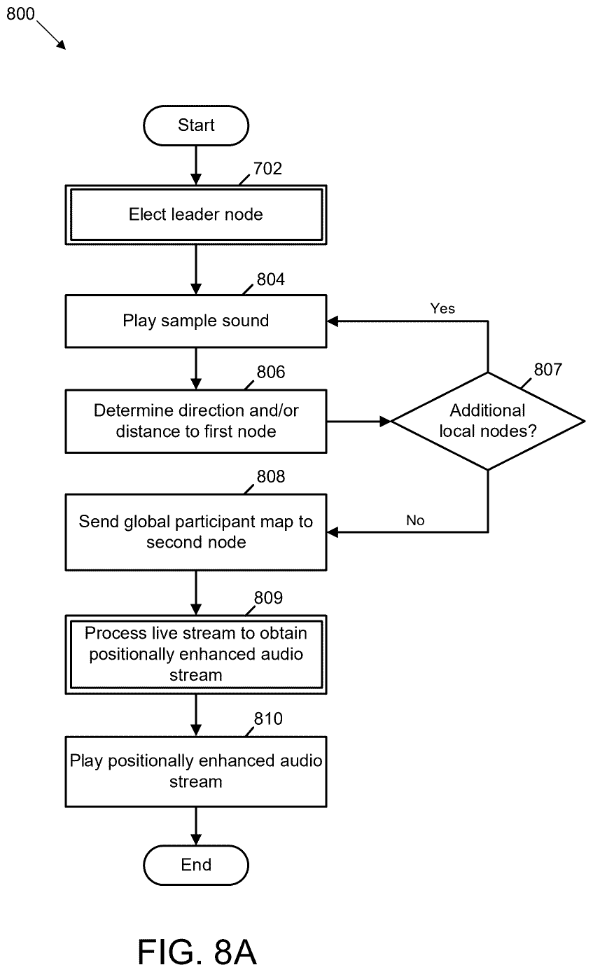

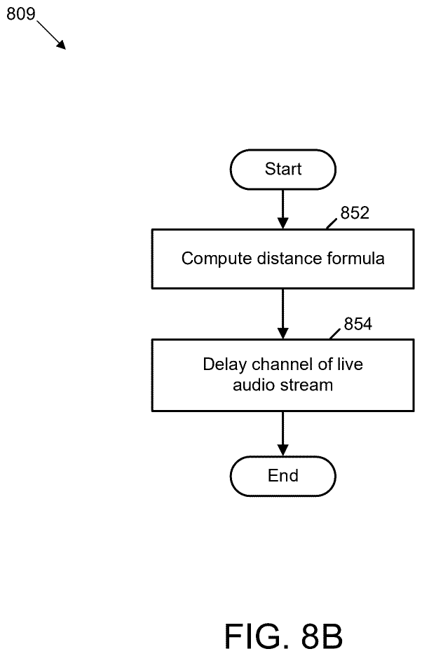

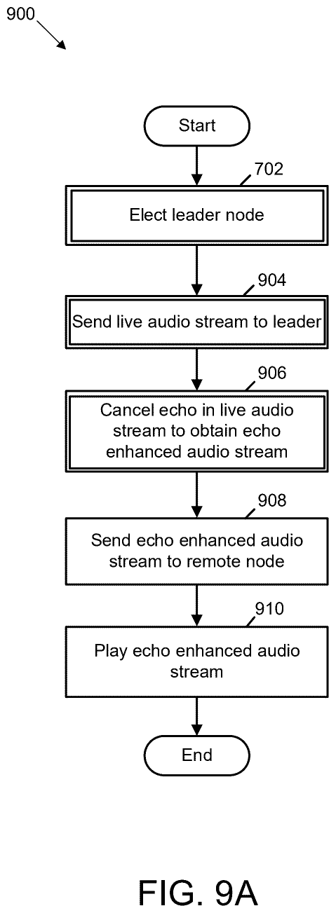

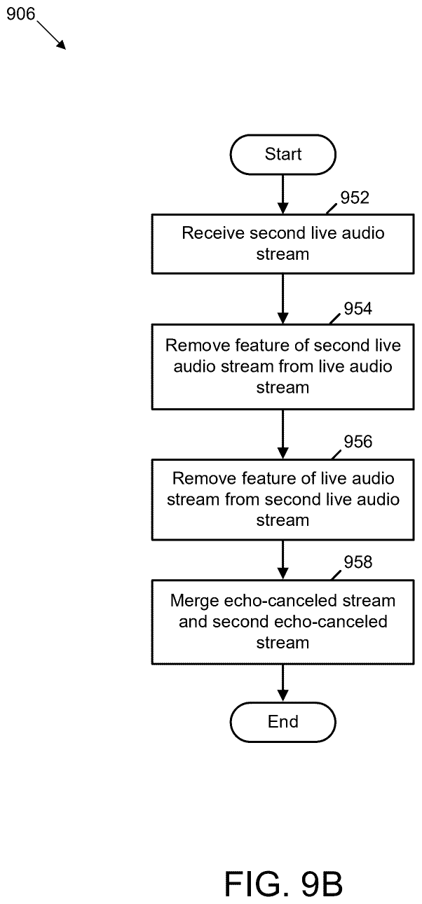

Next, a first follower node of the plurality of computing nodes can send 704 a first audio stream to the leader node. For example, in the case the method 700 is operated to produce a positionally enhanced audio stream, sending 704 the first audio stream may include playing a sample sound and/or transmitting a wireless signal, as described in FIG. 8A below. Alternatively or additionally, in the case of the echo enhanced audio stream, sending 704 the first audio stream may include sending a live audio stream, as described in the example of FIG. 9A below. In some examples, the first follower node may be a local node in a hybrid work mode meeting between local and remote nodes, such as any of the nodes 102 in the example of FIG. 1.

Next, the leader node can process 706 the first audio stream to obtain an output based on the first audio stream. In the case of the positionally enhanced audio stream, processing 706 the first audio stream may include determining a global participant map including the relative positions of the local nodes, while in the case of the echo enhanced audio stream, processing 706 the first audio stream may include canceling echo, as described below.

Next, the leader node can send 708 the obtained processing output to a second node. For example, the leader node may send 708 the processing output to a local node in the case of a positionally enhanced audio stream, and/or to a remote node in the case of an echo enhanced audio stream.

Next, a remote node can play 710 an enhanced audio stream based on the output. The enhanced audio stream may comprise the echo enhanced audio stream and/or the positionally enhanced audio stream. In various examples, the enhanced audio stream may be computed by the leader node, by one or more local follower nodes, and/or by the remote node itself, as described in FIGS. 8A-8B, 9A-9B, and 10 below. In particular, the positionally enhanced case will be described in FIG. 8A below, and the echo enhanced case in FIG. 9A below. In some examples, the enhanced audio stream may be both positionally enhanced and echo enhanced, and/or may include any other enhanced audio stream, and is not limited by the present disclosure.

The method 700 can then end.

FIG. 8A is a flow diagram of a process 800 for positional audio enhancement, in accordance with an example of the present disclosure. In this example, the process 800 may provide additional details of the process 700 of FIG. 7 for a case where the enhanced audio stream includes a positionally enhanced audio stream.

In various examples, the process 800 may be implemented by a plurality of computing nodes, which may include local nodes and/or remote nodes, as in the examples of FIGS. 1 and 7 above. Alternatively or additionally, the process 800 may be executed by a single device, or may be implemented within a virtualization infrastructure, as described in the example of FIG. 11 below, and is not limited by the present disclosure. In some examples, the process 800 may enhance an audio stream, such as from a distance or hybrid work mode meeting, to a positionally enhanced audio stream, as described in the examples of FIGS. 1, 4A-4C, and 5 above. In some examples, the process 800 may be performed in conjunction with the process 900 of FIG. 9A below, and/or any other audio enhancement process, and is not limited by the present disclosure.

As shown in FIG. 8A, the process 800 for positionally enhancing an audio output starts with the plurality of computing nodes electing 702 one of the plurality of computing nodes as a leader node, as in the example of FIG. 7 above. In some examples, electing 702 a leader node is based on the capacity of each node, for example by selecting the node with the greatest capacity as the leader. This process is described in greater detail in the examples of FIG. 3 above and FIG. 10 below. In some examples, the elected leader node can process live audio streams from the other nodes, for example in a centralized processing mode, as described below. In some examples, a normal vector or normal direction to the leader node can be set as a reference normal vector, such that the audio streams are positionally enhanced relative to the reference normal vector, as described in the examples of FIGS. 4A and 8B.

Next, a first follower node of the plurality of computing nodes can play 804 a sample sound. For example, the first follower node may be a local node in a hybrid work mode meeting between local and remote nodes, such as any of the nodes 102 in the example of FIG. 1. For example, the first follower node may be in the same physical room as the leader node. In some examples, the leader node may iteratively request each local follower node to play 804 a sample sound.

In some examples, sending 704 the first audio stream of the method 700 of FIG. 7 can correspond to the first follower node playing 804 the sample sound. In some examples, the first follower node can play 804 the sample sound using one or more audio speakers, and the leader node can sense the sample sound using an array of microphones.

Alternatively or additionally, in some examples the first follower node can transmit a wireless signal, such as a cellular, Bluetooth, and/or near-field communication (NFC) signal. In such cases, the leader node may use a signal strength of the transmitted wireless signal to determine a distance to the first follower node. For example, the leader node may possess information about the strength of the transmitted signal, or the signal may include information describing its own strength. Accordingly, the leader node can measure the signal strength, determine the amount of attenuation of the received signal, and use this to determine the distance to the first follower node.

Next, the leader node can determine 806 a direction and/or a distance to the first node. In some examples, determining 806 the direction and/or distance can be based on the relative delays of the sample sound, as sensed by respective microphones of a microphone array of the leader node, as described in the example of FIG. 4A above. For example, the leader node may use a difference in timing of the sample sound, as sensed by a respective pair of microphones of a microphone array, multiplied by the speed of sound, to compute a difference in distance traveled by the sample sound. In some examples, the leader node may have a microphone array including at least three microphones, and therefore may use multiple timing differences between respective pairs of microphones to compute a direction and/or a distance to the first node, as described in FIG. 4A. In some examples, if the leader node and/or other nodes are only able to use a single microphone, the system may generate pseudo-positional information.

In some examples, processing 706 the first audio stream of the method 700 of FIG. 7 can correspond to the leader node determining 806 a direction and/or a distance to the first node. In some examples, the processing output of the method 700 of FIG. 7 can correspond to a global participant map comprising the determined direction and/or distance.

For example, the leader node may determine 806 a direction and/or a distance to all local nodes, and/or to any subset of the local nodes, and therefore the global participant map may include all these determined directions and/or distances. In some examples, the leader node may iteratively request each local follower node to play 804 a sample sound, and then determine 806 the direction and/or distance to each respective local follower node. This procedure can continue until all the follower nodes' positions relative to the reference normal vector are detected.

In some examples, determining the direction and/or distance can include a beamforming and/or time difference of arrival (TDOA) analysis.

Accordingly, the leader node can determine 807 whether additional local follower nodes remain to be located. If so, the process may 800 return to the operation 804, so that the leader node can request another respective local node to play a sample sound. If no additional local follower nodes remain to be located, the process may continue to the operation 808.

Next, the leader node can send 808 the global participant map to a second node. In some examples, the second node may be a local node. In other examples, the second node may be a remote node, depending on the mode of operation. In some examples, depending on the mode of operation, the leader node sends 808 the global participant map both to local and remote nodes. Alternatively, in some cases, the leader node may use a centralized processing mode, and therefore may not send the global participant map to any other nodes.

In some examples, the leader node may send 808 the global participant map to the second node via the cluster, e.g. via the established WANET. Alternatively or additionally, in various examples, the leader node may send 808 the global participant map to the second node via another network, such as a local or wide area network or the Internet, via a cellular, Bluetooth, or NFC connection, or via any other means of transmission.

In some examples, the requests can be broadcast to all the local follower nodes in the cluster, so other members can also calculate a position relative to their own normal vector. This information can be shared and used to calibrate the location information in the global view. The global view of position information detected by the leader node can be broadcast to all local follower nodes in the cluster. Based on this information, each local follower node calculates its normal vector relative to the reference normal vector, so that for each node, not only the position information, but also its orientation information can be obtained.

In some examples, the operation of sending 708 the obtained processing output to a second node in the method 700 of FIG. 7 can correspond to the leader node sending 808 the global participant map to the second node. The sent output of FIG. 7 can correspond to the global participant map, which includes the determined direction and/or distance.

Next, the system can process 809 a live audio stream based on the global participant map to obtain a positionally enhanced audio stream. As described in the example of FIG. 5 above, the method 800 may make use of various modes of operation to process 809 the live stream. In some examples, the mode may be predetermined, whereas in other cases, the mode may be set by a user option.

Accordingly, in various examples, the live audio stream may be processed 809 by the leader node, by one or more local follower nodes, and/or by one or more remote nodes, depending on the mode of operation. As described in the example of FIG. 5 above, the leader node can process 809 the live audio stream in a centralized processing mode, the local follower nodes can process 809 the live audio stream in a distributed processing mode, or the remote nodes can process 809 the live audio stream in a remote processing mode. In some examples, processing 809 the live audio stream may be performed at least by the second node, having received the global participant map in the operation 808, and may be based on the received global participant map.

In some examples, the live audio stream may include the audio captured from microphones in a meeting, for example in a physical room with the leader node 104 and local follower nodes 102, as illustrated in FIG. 1 above. In some examples, multiple live audio streams may be processed 809, and/or the live audio stream may be a respective one of a plurality of live audio streams. For example, in the remote processing mode or the centralized processing mode, a remote node or the leader node, respectively, may process a plurality of live streams received from some, or all, of the local follower nodes. In the case of a plurality of streams, processing 809 the live audio stream may also include merging the plurality of processed streams into a single positionally enhanced output stream. Alternatively or additionally, in some examples, the live stream may be a single live stream. For example, in the case of the distributed processing mode, each local follower node may process 809 its own captured live stream.

In an example, processing 809 the live audio stream can include adjusting relative delays in channels (e.g., stereo channels) of the live audio stream based on the positions of the individual nodes of the global participant map, thereby obtaining the positionally enhanced audio stream. Processing 809 the live audio stream is described in greater detail in the examples of FIGS. 4B-4C above and FIG. 8B below.

Next, the remote node can play 810 the positionally enhanced audio stream. For example, in the case of the distributed processing mode, each local node may send its respective processed, positionally enhanced audio stream to the respective remote node, and the remote node may merge the plurality of positionally enhanced audio stream, and play 810 the merged positionally enhanced stream. In the case of the centralized processing mode, the leader node may send a single merged processed, positionally enhanced audio stream to the respective remote node, and the remote node may play 810 the received stream. In the case of the remote processing mode, each local node may send its respective live audio stream to the respective remote node, and the remote node may process 809 the streams, merge them into a single positionally enhanced stream, and play 810 the merged positionally enhanced stream.

Accordingly, when the remote node plays 810 the positionally enhanced audio stream, a user of the remote node can hear a reconstruction of the actual positions of local members of the meeting based on the global participant map, for example played by a stereo headset or speakers, as described in the example of FIG. 4B above.

The process 800 may then end.

FIG. 8B is a flow diagram of a process 809 for adjustment of positional audio, in accordance with an example of the present disclosure. In this example, the process 809 may provide additional details of the operation 809 of FIG. 8A. In various examples, the process 809 may be implemented by a plurality of computing nodes, which may include local nodes and/or remote nodes, as in the examples of FIGS. 1 and 7 above. Alternatively or additionally, the process 809 may be executed by a single device, such as any of the local and/or remote nodes, or may be implemented within a virtualization infrastructure, as described in the example of FIG. 11 below, and is not limited by the present disclosure. In various examples, in a centralized processing mode, the process 809 may be implemented by a leader node, while in a distributed processing mode, the process 809 may be implemented by one or more follower nodes, and in a remote processing mode, the process 809 may be implemented by one or more remote nodes.

As shown in FIG. 8B, the process 809 for adjustment of positional audio starts with the system computing 852 a distance formula. As in the examples of FIGS. 4B and 4C above, the leader node, follower node, remote node, and/or other computing device may determine a relative delay Δt between the channels corresponding to two stereo speakers or earphones by a formula such as

$${C}_{s} Δ t = \sqrt{{D}^{2} + \frac{{L}^{2}}{4} + DL cos θ} - \sqrt{{D}^{2} + \frac{{L}^{2}}{4} - DL cos θ}$$

Here cₛ is the speed of sound, L is the distance between the two stereo speakers or earphones, D is the distance of the sound source from the leader node according to the global position map, and θ is an azimuthal angle relative to the leader node's reference normal vector according to the global position map, as in the examples of FIGS. 4A-4C.

Next, the system can delay 854 one or more channels of the live audio stream based on the computed distance formula. For example, in a case when the live audio stream has two stereo channels, the leader node, follower node, remote node, and/or other computing device may introduce the relative delay Δt between the channels, as computed in operation 852. The system may then merge the live streams of the various meeting participants into a single positionally enhanced audio stream, as described above.

The process 809 can then end.

FIG. 9A is a flow diagram of a process 900 for echo cancellation audio enhancement, in accordance with an example of the present disclosure. In this example, the process 900 may provide additional details of the process 700 of FIG. 7 for a case where the enhanced audio stream includes an echo enhanced audio stream.

In various examples, the process 900 may be implemented by a plurality of computing nodes, which may include local nodes and/or remote nodes, as in the examples of FIGS. 2 and 7 above. Alternatively or additionally, the process 900 may be executed by a single device, or may be implemented within a virtualization infrastructure, as described in the example of FIG. 11 below, and is not limited by the present disclosure. In some examples, the process 900 may enhance an audio stream, such as from a distance or hybrid work mode meeting, to an echo enhanced audio stream, as described in the examples of FIGS. 2 and 6 above. In some examples, the process 900 may be performed in conjunction with the process 800 of FIG. 8A above, and/or any other audio enhancement process, and is not limited by the present disclosure.

As shown in FIG. 9A, the process 900 for echo cancellation audio enhancement starts with the plurality of computing nodes electing 702 one of the plurality of computing nodes as a leader node, as in the example of FIG. 7 above. In some examples, electing 702 a leader node is based on the capacity of each node, for example by selecting the node with the greatest capacity as the leader. This process is described in greater detail in the examples of FIG. 3 above and FIG. 10 below. In some examples, the elected leader node can process live audio streams from the other nodes, as described below.

Next, a first follower node of the plurality of computing nodes can send 904 a live audio stream to the leader node. For example, the first follower node may be a local node in a hybrid work mode meeting between local and remote nodes, such as any of the local follower nodes 102 in the example of FIG. 2. For example, the first follower node may be in the same physical room as the leader node. In various examples, all the local nodes, and/or any subset of the local nodes, may send respective live audio streams to the leader node, and the leader node may process all the received streams.

In some examples, the first follower node may send 904 the live audio stream to the leader node via the cluster, e.g. via the established WANET. Alternatively or additionally, in various examples, the first follower node may send 904 the live audio stream to the leader node via another network, such as a local or wide area network or the Internet, via a cellular, Bluetooth, or NFC connection, or via any other means of transmission.

In some examples, sending 704 the first audio stream of the method 700 of FIG. 7 can correspond to the first follower node sending 904 the live audio stream to the leader node. The first audio stream of the method 700 can correspond to the live audio stream of this example.

In some examples, sending 904 the live audio stream to the leader node can involve the follower node removing a feature of a remote audio stream from a live audio stream. For example, after receiving the remote audio stream, the follower node may process its own locally captured audio stream by removing the remote audio stream.

In some examples, the follower node can use an APM of the remote audio stream to process its locally captured stream. As described above, the APM may be the core data structure for audio processing for the specific audio stream. Thus, in some examples, the follower node can use the remote APM to extract audio features of the remote stream, and subsequently to remove the remote feature from the locally captured stream. For example, Alice's follower node 102a may execute a procedure such as the following:

```
while (true) {
  // extract remote audio features
  APM_Remote.ProcessReverseStream(Stream_Remote);
  // remove remote audio from locally captured stream
  APM_Remote.ProcessStream(Stream_Alice);
  // send the stream to the Leader machine
  SendStreamTo(Bob);
}
```

Sending 904 the live audio stream to the leader node is described further in the examples of FIGS. 4B-4C above.

Next, the leader node can cancel 906 echo in the live audio stream to obtain an echo enhanced audio stream. In some examples, processing 706 the first audio stream of the method 700 of FIG. 7 can correspond to the leader node canceling 906 echo in the live audio stream to obtain the echo enhanced audio stream. The processing output of the method 700 of FIG. 7 can correspond to the echo enhanced audio stream.

As illustrated in FIG. 2 above, once the leader node has been selected, the system can enter its operating phase. As in the example of FIG. 2, each node may create an APM data structure for the remote audio stream. The meeting client may be disconnected from the follower nodes' physical audio input devices, so that a single processed stream from the leader node may be sent to the remote nodes.

In some examples, for each local follower node, the leader node (e.g., Bob's machine in the example of FIG. 2) can create a specific APM, as well as an APM for the leader node's (e.g., Bob's) own input stream. For example, Alice's node 102a of the example of FIG. 2 may capture a stream with Alice's voice as well as other local and/or remote voices, denoted (A+b+c+r), as described above. Accordingly, the follower node 102a can use an APM for one or more remote nodes, denoted APM_remote, to extract features of one or more remote audio streams, and remove these features from its own captured audio stream. After using APM_remote to remove the remote component, Alice's node 102a can send the resulting stream, denoted A+b+c, to the leader node.

Accordingly, the system can obtain a cleaned audio stream for each local follower node (for example the nodes of Alice, Bob, and Charlie). Each meeting attendee's voice can be captured primarily by the nearest microphone. The system may then merge these streams into a single merged audio stream.

Canceling 906 echo in the live audio stream is described in greater detail in the examples of FIGS. 4B-4C above and FIG. 9B below.

Next, the leader node can send 908 the merged, echo enhanced audio stream to one or more remote nodes. In some examples, the leader node may send 908 the echo enhanced audio stream to the one or more remote nodes via the Internet or any other network, or via any other means of transmission. For example, the leader node may send 908 the merged stream to the meeting client.

In some examples, the operation of sending 708 the obtained processing output to a second node in the method 700 of FIG. 7 can correspond to the leader node sending 908 the echo enhanced audio stream to the one or more remote nodes. The second node of FIG. 7 can correspond to the remote node.

Next, the one or more remote nodes can play 910 the echo enhanced audio stream received from the leader node. Since each attendee's voice has been captured by the nearest microphone, the disclosed system and methods can achieve optimal audio sensitivity for each speaker. Moreover, because echoes from the remote and local participants are removed from each stream, the disclosed system and methods can prevent or greatly reduce echo and feedback noise.

The method 900 can then end.

FIG. 9B is a flow diagram illustrating further details 906 of canceling echo, in accordance with an example of the present disclosure. In this example, the process 906 may provide additional details of the operation 906 of FIG. 9A. In various examples, the process 906 may be implemented by a plurality of computing nodes, which may include local nodes and/or remote nodes, as in the examples of FIGS. 2 and 7 above. Alternatively or additionally, the process 906 may be executed by a single device, such as any of the local and/or remote nodes, or may be implemented within a virtualization infrastructure, as described in the example of FIG. 11 below, and is not limited by the present disclosure. In some examples, the process 906 may be implemented by a leader node.

As shown in FIG. 9B, the process 906 for canceling echo starts with the leader node receiving 952 a second live audio stream.

Next, the leader node can remove 954 a feature of the second live audio stream from the live audio stream to obtain a first echo-canceled stream. In an example, upon receiving audio streams from the follower nodes, the leader node (e.g., Bob's machine in the example of FIG. 2 above) can perform two procedures.

First, the leader node can maintain an APM for each follower node. As described above, the APM may be the core data structure for audio processing for the specific audio stream. Thus, in some examples, the leader node can use the specific APM to extract audio features for each audio stream. For example, the APM for Alice can contain audio features for the audio stream captured by Alice's microphone. In an example, Alice's voice may have far more contributions to these audio features. Accordingly, this APM for Alice can be used to cancel Alice's voice captured by other follower nodes, e.g. by Bob's and Charlie's microphones.

Accordingly, the leader node may use APM_Alice to extract a feature from Stream_Alice (A+b+c), and can use APM_Charlie to extract a feature from Stream_Charlie (C+a+b). Since Alice is the principal component in (A+b+c), APM_Alice can contain Alice's voice feature, and likewise APM_Charlie can contain Charlie's voice feature.

Second, the leader node can perform echo cancellation for each stream by using all the other APMs. For example, the leader node can apply APM_Alice and APM_Bob in turn to Stream_Charlie (C+a+b), so that Alice and Bob's voice can be removed from Stream_Charlie, leaving only Charlie's voice. Thus, after processing Stream_Charlie becomes (C), and similarly Stream_Alice becomes (A), and Stream_Bob becomes (B).

Next, the leader node can remove 956 a feature of the live audio stream from the second live audio stream to obtain a second echo-canceled stream. For example, after applying APM_Alice to Stream_Charlie to remove Alice's voice from Charlie's audio stream, the leader node can then applying APM_Charlie to Stream_Alice to remove Charlie's voice from Alice's audio stream.

On the leader node, each APM may continually extract audio features from the respective audio stream, and thus can continually cancel the related voice from other streams. For example, the leader node may follow a procedure described by the following pseudo code:

```
while (true) {
  // extract Alice voice features from Alice's captured
  stream
  APM_Alice.ProcessReverseStream(Stream_Alice);
  // remove Alice's voice from Bob's captured stream
  APM_Alice.ProcessStream(Stream_Bob);
  // remove Alice's voice from Charlie's captured stream
  APM_Alice.ProcessStream(Stream_Charlie);
  // extract Bob voice features from Bob's captured
  stream
  APM_Bob.ProcessReverseStream(Stream_Bob);
  // remove Bob's voice from Alice's captured stream
  APM_Bob.ProcessStream(Stream_Alice);
  // remove Bob's voice from Charlie's captured stream
  APM_Bob.ProcessStream(Stream_Charlie);
  // extract Charlie's voice feature and remove
  Charlie's voice
  from Bob and Alice captured stream
  ...-...
}
```

Next, the leader node can merge 958 the first echo-canceled stream and the second echo-canceled stream to obtain the echo enhanced audio stream. For example, after feature extraction and echo cancellation processing, the multiple audio streams can then be merged into a single stream and sent to the remote node as a single enhanced audio stream for the physical room.

The method 906 can then end.

FIG. 10 is a flow diagram illustrating further details 702 of electing a leader node, in accordance with an example of the present disclosure. In this example, the process 702 may provide additional details of the operation 702 of FIGS. 7, 8A, and 9A. In some examples, electing a leader node is based on the capacity of each node, for example by selecting the node with the greatest capacity as the leader. In various examples, the process 702 may be implemented by a plurality of computing nodes, which may include local nodes and/or remote nodes, as in the example of FIG. 3 above. Alternatively or additionally, the process 702 may be executed by a single device, or may be implemented within a virtualization infrastructure, as described in the example of FIG. 11 below, and is not limited by the present disclosure.

As shown in FIG. 10, the process 702 for electing a leader node starts with obtaining 1002 a network accessible by the plurality of computing nodes. In some examples, the local nodes at the same site (e.g., in the same physical room) can discover each other. For example, each node may broadcast its machine identity and meeting identity to its neighbors, for example via Bluetooth or NFC. Upon receiving identity information from neighbors, each machine then filters out those nodes with meeting identities not corresponding to the current meeting. A cluster can then be established among all the nodes that have not been filtered out, for example via Bluetooth or a WANET.

Next, a respective node of the plurality of computing nodes can broadcast 1004 the respective node's resource capacity via the established network and/or a wireless signal. For example, each respective node can broadcast 1004 its CPU type, number of CPUs, memory capacity, current computing load, and/or any other resource capacity.

Next, a respective node can receive 1006 broadcasted information about other nodes' resource capacities. In various examples, the respective node may receive 1006 information about its neighbors' resource capacity or about all nodes' resource capacities.

Upon receiving resource reports from its neighbors, each node can decide 1008 whether to adopt a candidate or follower status for the election procedure. For example, some nodes may spontaneously choose not to pursue leader candidacy, for example if the nodes have less resource capacity than their neighbors (e.g., less powerful CPU type, lower number of CPUs, lower memory capacity, higher current computing load, etc.), thereby accelerating and optimizing the election process. Conversely, those nodes with relatively high resource capacity may volunteer as candidates to become the leader node. In some examples, the resource capacity may be quantified using one or more metrics, such as the CPU type, number of CPUs, memory capacity, computing load, communication bandwidth, number of microphones, and/or some function thereof.

Next, electing the leader node can comprise executing 1010 a consensus process to elect the leader node based on the nodes' resource capacities, for example by selecting the node with the greatest resource capacity as the leader. In some examples, the consensus process can include a Raft consensus process and/or a Paxos consensus process. Alternatively or additionally, the leader node election method 702 can use any other consensus process, and is not limited by the present disclosure. In some examples, if two nodes have equal capacity, the system may apply a precedence rule.

In some examples, while executing 1010 the consensus process, the node elected as the leader can obtain an election result indicating it has won the election. For example, if a candidate node receives more than a threshold number of votes (e.g., a quorum of votes) and has voted for itself, the node may determine itself as the leader. In this case, receiving the quorum of votes may constitute the election result. In various examples, the quorum may indicate a majority of votes, or may be a parameter that can be set, for example by a user. In the case of the Paxos consensus process, the nodes may be guaranteed to agree on the election results, for example, on which node has been elected as leader.

In some examples, if the selected leader node subsequently crashes, goes offline, or experiences a resource shortage at any time, the cluster may return to the leader election phase 702 and elect a new leader node. Any data from the old leader node's APMs can be transferred to the new leader, so as to minimize “cold-start” issues and accelerate the procedure. In one example of positional audio enhancement, if the leader node changes, the system may retain the same positional information, such as the same global participant map, and the new leader node may process the audio streams based on the existing map.

The method 702 can then end.

### Computer System Configured to Enhance an Audio Output

FIG. 11 is a block diagram of an example system 1100 for enhancing an audio output, in accordance with an example of the present disclosure. The system 1100 includes a digital workspace server 1102 that is capable of carrying out the methods disclosed herein. The user's association with the endpoint 1106 may exist by virtue of, for example, the user being logged into or authenticated to the endpoint 1106. While only one endpoint 1106 and three example application servers 1108 are illustrated in FIG. 11 for clarity, it will be appreciated that, in general, the system 1100 is capable of hosting connections between an arbitrary number of endpoints and an arbitrary number of application servers. In some examples, the endpoints 1106 may include the leader and/or follower nodes of the examples of FIGS. 1-2 above. In some examples, instructions implementing any of the methods disclosed herein may be stored in some or all of the endpoints 1106.

The digital workspace server 1102, the endpoint 1106, and the application servers 1108 communicate with each other via a network 1104. The network 1104 may be a public network (such as the Internet) or a private network (such as a corporate intranet or other network with restricted access). Other examples may have fewer or more communication paths, networks, subcomponents, and/or resources depending on the granularity of a particular implementation. For example, in some implementations at least a portion of the application functionality is provided by one or more applications hosted locally at an endpoint. Thus references to the application servers 1108 should be understood as encompassing applications that are locally hosted at one or more endpoints. It should therefore be appreciated that the examples described and illustrated herein are not intended to be limited to the provision or exclusion of any particular services and/or resources.

The digital workspace server 1102 is configured to host the positional audio and/or echo enhancement systems and methods disclosed herein, and the server virtualization agent 1122. The digital workspace server 1102 may comprise one or more of a variety of suitable computing devices, such as a desktop computer, a laptop computer, a workstation, an enterprise-class server computer, a tablet computer, or any other device capable of supporting the functionalities disclosed herein. A combination of different devices may be used in certain examples. As illustrated in FIG. 11, the digital workspace server 1102 includes one or more software programs configured to implement certain of the functionalities disclosed herein as well as hardware capable of enabling such an implementation. In some examples, instructions implementing any of the methods disclosed herein may be virtualized by the digital workspace server 1102 and/or the server virtualization agent 1122. For example, the centralized processing performed by the leader node 104 and/or processing performed by the follower nodes 102 of the examples of FIGS. 1-2 may be virtualized.

As noted above, in certain examples the endpoint 1106 can be a computing device that is used by the user. Examples of such a computing device include but are not limited to, a desktop computer, a laptop computer, a tablet computer, and a smartphone. The digital workspace server 1102 and its components are configured to interact with a plurality of endpoints. In an example, the user interacts with a plurality of workspace applications 1112 that are accessible through a digital workspace 1110. The user's interactions with the workspace applications 1112 and/or the application servers 1108 may be tracked, monitored, and analyzed by the workspace service. Any microapps can be made available to the user through the digital workspace 1110, thereby allowing the user to view information and perform actions without launching (or switching context to) the underlying workspace applications 1112. The workspace applications 1112 can be provided by the application servers 1108 and/or can be provided locally at the endpoint 1106. For instance, the example workspace applications 1112 include a SaaS application 1114, a web application 1116, and an enterprise application 1118, although any other suitable existing or subsequently developed applications can be used as well, including proprietary applications and desktop applications. To enable the endpoint 1106 to participate in a virtualization infrastructure facilitated by the broker computer 1124 and involving the server virtualization agent 1122 as discussed herein, the endpoint 1106 also hosts the client virtualization agent 1120.

The broker computer 1124 is configured to act as an intermediary between the client virtualization agent 1120 and the server virtualization agent 1122 within the virtualization infrastructure. In some examples, the broker computer 1124 registers virtual resources offered by server virtualization agents, such as the server virtualization agent 1122. In these examples, the broker computer 1124 is also configured to receive requests for virtual resources from client virtualization agents, such as the client virtualization agent 1120, and to establish virtual computing sessions involving the client virtualization agent 1120 and the server virtualization agent 1122.

### Computing Device

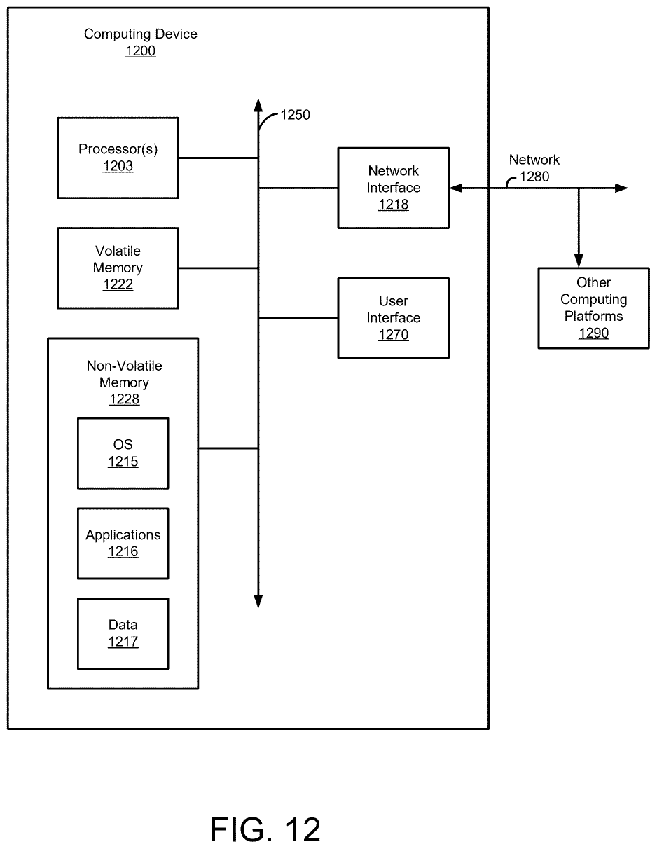

FIG. 12 is a block diagram of a computing device configured to implement various systems and processes in accordance with examples disclosed herein, for example the leader, follower, and/or remote nodes described above.

The computing device 1200 includes one or more processor(s) 1203, volatile memory 1222 (e.g., random access memory (RAM)), non-volatile memory 1228, a user interface (UI) 1270, one or more network or communication interfaces 1218, and a communications bus 1250. The computing device 1200 may also be referred to as a client device, computing device, endpoint device, computer, or a computer system.

The non-volatile (non-transitory) memory 1228 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 1270 can include a graphical user interface (GUI) (e.g., controls presented on a touchscreen, a display, etc.) and one or more input/output (I/O) devices (e.g., a mouse, a keyboard, a microphone, one or more speakers, one or more cameras, one or more biometric scanners, one or more environmental sensors, and one or more accelerometers, one or more visors, etc.).

The non-volatile memory 1228 stores an OS 1215, one or more applications or programs 1216, and data 1217. The OS 1215 and the application 1216 include sequences of instructions that are encoded for execution by processor(s) 1203. Execution of these instructions results in manipulated data. Prior to their execution, the instructions can be copied to the volatile memory 1222. In some examples, the volatile memory 1222 can include one or more types of RAM and/or a cache memory that can offer a faster response time than a main memory. Data can be entered through the user interface 1270 or received from the other I/O device(s), such as the network interface 1218. The various elements of the device 1200 described above can communicate with one another via the communications bus 1250.

The illustrated computing device 1200 is shown merely as an example client device or server and can be implemented within any computing or processing environment with any type of physical or virtual machine or set of physical and virtual machines that can have suitable hardware and/or software capable of operating as described herein.

The processor(s) 1203 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can include one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor(s) 1203 can be analog, digital or mixed. In some examples, the processor(s) 1203 can include one or more local physical processors or one or more remotely located physical processors. A processor including multiple processor cores and/or multiple processors can provide functionality for parallel, simultaneous execution of instructions or for parallel, simultaneous execution of one instruction on more than one piece of data.

The network interfaces 1218 can include one or more interfaces to enable the computing device 1200 to access a computer network 1280 such as a Local Area Network (LAN), a Wide Area Network (WAN), a Personal Area Network (PAN), or the Internet through a variety of wired and/or wireless connections, including cellular connections, Bluetooth connections, and/or NFC connections. In some examples, the network 1280 may allow for communication with other computing devices 1290, to enable distributed computing. The network 1280 can include, for example, one or more private and/or public networks over which computing devices can exchange data.

In described examples, the computing device 1200 can execute an application on behalf of a user of a client device. For example, the computing device 1200 can execute one or more virtual machines managed by a hypervisor. Each virtual machine can provide an execution session within which applications execute on behalf of a user or a client device, such as a hosted desktop session. The computing device 1200 can also execute a terminal services session to provide a hosted desktop environment. The computing device 1200 can provide access to a remote computing environment including one or more applications, one or more desktop applications, and one or more desktop sessions in which one or more applications can execute.

The processes disclosed herein each depict one particular sequence of acts in a particular example. Some acts are optional and, as such, can be omitted in accord with one or more examples. Additionally, the order of acts can be altered, or other acts can be added, without departing from the scope of the apparatus and methods discussed herein.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

1. A method of using multiple audio streams to enhance an audio output, comprising:
electing, by a plurality of computing devices, one of the plurality of computing devices as a leader device;
sending, by a first follower device of the plurality of computing devices, a first audio stream to the leader device;
processing, by the leader device, the first audio stream to obtain an output based on the first audio stream;
sending, by the leader device, the output to a second device; and
playing, by a remote device, an enhanced audio stream based on the output, wherein the enhanced audio stream comprises an echo enhanced audio stream and/or a positionally enhanced audio stream.

2. The method of claim 1, wherein:
playing the enhanced audio stream comprises playing the positionally enhanced audio stream;
sending, by the first follower device, the first audio stream comprises playing, by the first follower device, a sample sound;
processing the first audio stream comprises determining a direction and/or a distance to the first device;
processing the first audio stream to obtain the output comprises processing the first audio stream to obtain a global participant map comprising the determined direction and/or distance; and
processing a live audio stream based on the global participant map to obtain the positionally enhanced audio stream.

3. The method of claim 2, wherein processing the live audio stream based on the global participant map comprises delaying at least one channel of the live audio stream based on the global participant map.

4. The method of claim 3, wherein delaying the at least one channel further comprises computing a distance formula based on a square of the distance and/or a cosine of an angle associated with the direction.

5. The method of claim 2, wherein determining the direction and/or distance to the first device comprises one or more of:
sensing the sample sound by a plurality of microphones of the leader device; and
determining, by the leader device, a signal strength of a wireless signal transmitted by the first device.

6. The method of claim 2, wherein processing the live audio stream based on the global participant map comprises one or more of:
processing, by the leader device, the live audio stream;
processing, by the second device, the live audio stream, wherein the second device differs from the remote device; and
processing, by the remote device, the live audio stream.

7. The method of claim 2, wherein determining the direction and/or distance comprises performing a beamforming and/or time difference of arrival (TDOA) analysis.

8. The method of claim 1, wherein:
playing the enhanced audio stream comprises playing the echo enhanced audio stream; sending the first audio stream comprises sending a live audio stream;
processing the first audio stream comprises canceling echo in the live audio stream to obtain the echo enhanced audio stream;
processing the first audio stream to obtain the output comprises processing the first audio stream to obtain the echo enhanced audio stream; and
sending the output to the second device comprises sending the output to the remote device.

9. The method of claim 8, wherein canceling the echo in the live audio stream comprises:
receiving, by the leader device, a second live audio stream;
removing, by the leader device, a feature of the second live audio stream from the live audio stream to obtain a first echo-canceled stream;
removing, by the leader device, a feature of the live audio stream from the second live audio stream to obtain a second echo-canceled stream; and
merging, by the leader device, the first echo-canceled stream and the second echo-canceled stream to obtain the echo enhanced audio stream.

10. The method of claim 9, wherein removing the feature of the second live audio stream from the live audio stream comprises processing the live audio stream with an Audio Processing Module (APM) associated with the second live audio stream.

11. The method of claim 8, wherein sending the first audio stream to the leader device comprises removing, by the first follower device, a feature of a remote audio stream from the live audio stream, wherein the remote audio stream is received from the remote device.

12. The method of claim 1, wherein electing the leader device comprises: obtaining a network accessible by the plurality of computing devices;
broadcasting, by a respective device of the plurality of computing devices, a respective resource capacity of the respective device via the network or a wireless signal; and
executing a consensus process to elect the leader device based on the respective resource capacity.

13. The method of claim 12, wherein the consensus process comprises one or more of a Raft process or a Paxos process.

14. A computer system configured to enhance an audio output, the computer system comprising:
a memory; and
at least one processor coupled to the memory and configured, responsive to being elected by a plurality of computing devices as a leader device, to:
receive, from a first follower device of the plurality of computing devices, a first audio stream;
process the first audio stream to obtain an output based on the first audio stream, the output specifying an enhanced audio stream playable by a remote device, the enhanced audio stream comprising an echo enhanced audio stream and/or a positionally enhanced audio stream; and
send the output to a second device.

15. The computer system of claim 14, wherein:
the enhanced audio stream comprises the positionally enhanced audio stream;
to receive, from the first follower device, the first audio stream comprises to sense, via a plurality of microphones of the leader device, a sample sound played by the first follower device;
to process the first audio stream comprises to determine a direction and/or a distance to the first device;
the output comprises a global participant map comprising the determined direction and/or distance; and
the positionally enhanced audio stream is obtained based on a live audio stream and the global participant map.

16. The computer system of claim 14, wherein:
the enhanced audio stream comprises the echo enhanced audio stream; the first audio stream comprises a live audio stream;
to process the first audio stream comprises to cancel echo in the live audio stream to obtain the echo enhanced audio stream;
the output comprises the echo enhanced audio stream; and the second device comprises the remote device.

17. The computer system of claim 16, wherein to cancel the echo in the live audio stream comprises:
to receive a second live audio stream;
to remove a feature of the second live audio stream from the live audio stream to obtain a first echo-canceled stream;
to remove a feature of the live audio stream from the second live audio stream to obtain a second echo-canceled stream; and
to merge the first echo-canceled stream and the second echo-canceled stream to obtain the echo enhanced audio stream.

18. A non-transitory computer readable medium storing executable sequences of instructions to enhance an audio output, the sequences of instructions comprising instructions to:
receive an election result indicative of being elected as a leader device of a plurality of computing devices;
receive, from a first follower device of the plurality of computing devices, a first audio stream;
process the first audio stream to obtain an output based on the first audio stream, the output specifying an enhanced audio stream playable by a remote device, the enhanced audio stream comprising an echo enhanced audio stream and/or a positionally enhanced audio stream; and
send the output to a second device.

19. The non-transitory computer readable medium of claim 18, wherein:
the enhanced audio stream comprises the positionally enhanced audio stream, wherein to receive, from the first follower device, the first audio stream comprises to sense, via a plurality of microphones of the leader device, a sample sound played by the first follower device;
to process the first audio stream comprises to determine a direction and/or a distance to the first device;
the output comprises a global participant map comprising the determined direction and/or distance; and
the positionally enhanced audio stream is obtained based on a live audio stream and the global participant map; or
the enhanced audio stream comprises the echo enhanced audio stream, wherein the first audio stream comprises a first live audio stream;
to process the first audio stream comprises to cancel echo in the first live audio stream to obtain the echo enhanced audio stream;
the output comprises the echo enhanced audio stream; and the second device comprises the remote device.

20. The non-transitory computer readable medium of claim 18, wherein to receive the election result indicative of being elected as the leader device comprises:
to obtain a network accessible by the plurality of computing devices;
to broadcast a first resource capacity via the network or a wireless signal;
to receive a respective resource capacity of a respective device of the plurality of computing devices; and
to execute a consensus process based on the first resource capacity and the respective resource capacity.
